(19) United States
(12) Patent Application Publication
(10) Pub. No.: US 2008/0209311 A1
(43) Pub. Date: Aug. 28, 2008

(54) On-line digital image editing with wysiwyg transparency

(76) Inventors: Alex Agronik, Jerusalem (IL); David Gross, Beitar Elite (IL); Ilan Meister, Karnei Shomron (IL); Gilan Israel, Jerusalem (IL); Avi Lowell, Tekoa (IL); David Brock, Mitzpe Yericho (IL); Steven Hesse, Jerusalem (IL)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/005,566

(22) Filed: Dec. 27, 2007

Related U.S. Application Data
(60) Provisional application No. 60/882,660, filed on Dec. 29, 2006.

(51) Int. Cl. G06F 17/00

(52) U.S. Cl. 715/234

(57) ABSTRACT

A method for editing includes processing a page of markup-language code using a browser program running on a computer so as to display the page content in a browser window on a computer screen. An embedded application embedded as an object in the markup-language code and running in the browser program is used to overlay an image in a transparent editing window over the browser window so that at least some of the content behind the editing window remains visible. The image in the transparent editing window is edited in response to user input, while at least some of the content remains visible behind the editing window. A characteristic of the image is modified and a reference to the image with the modified characteristic is placed in the markup-language code.

### CROSS-REFERENCE TO RELATED APPLICATION

This application claims the benefit of U.S. Provisional Patent Application 60/882,660, filed Dec. 29, 2006, whose disclosure is incorporated herein by reference.

### FIELD OF THE INVENTION

The present invention relates generally to image editing systems, and specifically to on-line image cropping and editing.

### BACKGROUND OF THE INVENTION

What You See Is What You Get (WYSIWYG) is used in computing to describe a system in which content during editing appears very similar to the final product. A WYSIWYG editor for HyperText Markup Language (HTML) allows the user to view on screen how a document will look when it is displayed in a browser. One example of a WYSIWYG editor for HTML is the FCKeditor, available at the FCKeditor web site (fckeditor.net). The FCKeditor is a lightweight on-line HTML editor with support for multiple browsers, programming languages and plug-ins.

U.S. Pat. No. 6,844,885, whose disclosure is incorporated herein by reference, describes a method for editing digital images with a simple architecture that lends itself to on-line image editing. A user interface displays a work area and receives image edit inputs, overlaying a grid on the work area. Grid elements are used to generate commands in response to the image edit inputs.

U.S. Pat. No. 7,209,149, whose disclosure is incorporated herein by reference, describes a method for cropping and synthesizing images with templates. A crop boundary is displayed with a reference point on an image to synthesize on the screen. Upon selecting a template having at least a frame, the crop boundary has a corresponding shape to that of the frame of the selected template and is variable in size while keeping the same shape and remains centered on the reference point. The crop boundary is moved on the screen through an operation device to position the reference point of the crop boundary on an appropriate point of the image to synthesize. The crop boundary is enlarged or reduced about the reference point, to bound an appropriate area of the image to synthesize. An image of the bounded area is cropped, and the cropped image is pasted in the frame of the template after the cropped image is enlarged or reduced in accordance with the size of the template.

### SUMMARY OF THE INVENTION

In an embodiment of the present invention a method is provided for editing. The method includes processing a page of markup-language code using a browser program running on a computer so as to display content of the page in a browser window on a computer screen. An embedded application, which is embedded as an object in the markup-language code, runs in the browser program, overlaying an image in a transparent editing window on the browser window so that at least some of the content behind the editing window is visible to a user of the computer. The image is edited in the transparent editing window in response to user input to the computer, modifying a characteristic of the image, while at least some of the content remains visible behind the editing window, and a reference to the image with the modified characteristic is placed in the markup-language code.

In some embodiments, after editing the image, the markup-language code is automatically edited using the embedded application running on the computer, so that when the content of the page is displayed, the image, with the modified characteristic, is displayed together with the content in a desired location. Automatically editing the markup-language code typically includes inserting one or more markup-language attributes associated with the image in the page of the markup-language code, and updating the attributes in response to the modified characteristic.

Typically, the embedded application is an interactive client application. The interactive client application usually includes at least one application type selected from a group of application types consisting of an applet, a script, and a browser plug-in.

In disclosed embodiments, overlaying an image includes creating an inline frame markup-language document containing the transparent editing window, and layering the inline frame markup-language document above another markup-language document corresponding to the page of markup-language code. In some embodiments, the inline frame markup-language document has at least one transparent style attribute.

In some embodiments, editing the image includes cropping the image.

In disclosed embodiments, the editing window includes a text entry box for receiving text from the user for association with the image, and automatically editing the markup-language code includes generating at least one markup-language attribute containing the text. At least one markup-language attribute is selected from a group of attributes consisting of ALT and TITLE attributes.

In some embodiments, processing the page of markup-language code includes downloading the page with the embedded application from a server to the computer, in response to a request from a client to the server to edit the image. Typically, editing the image includes modifying the characteristic of the image on the computer, and then uploading the modified characteristic to the server for application to a copy of the image held by the server.

There is further provided, according to an embodiment of the present invention, apparatus for editing, including:

a network interface, which is configured to communicate over a network with a client computer; and

a processor which is coupled to download over the network to the client computer a page of markup-language code including an embedded application, which is embedded as an object in the markup-language code, so as to cause a browser program running on the client computer to display content of the page in a browser window on a computer screen and to run the embedded application in the browser program,

wherein the embedded application, when run on the client computer, causes the client computer to overlay an image in a transparent editing window on the browser window so that at least some of the content behind the editing window is visible to a user of the computer, and to edit the image in the transparent editing window, responsively to input by the user to the computer, while the at least some of the content remains visible behind the editing window, so as to modify a characteristic of the image and place a reference to the image, with the modified characteristic, in the markup-language code.

Another embodiment of the invention provides a computer software product including a tangible computer-readable medium in which program instructions are stored, which instructions, when read by a server, cause the server to download to a client computer a page of markup-language code including an embedded application, which is embedded as an object in the markup-language code, so as to cause a browser program running on the client computer to display content of the page in a browser window on a computer screen and to run the embedded application in the browser program,

wherein the embedded application, when run on the client computer, causes the client computer to overlay an image in a transparent editing window on the browser window so that at least some of the content behind the editing window is visible to a user of the computer, and to edit the image in the transparent editing window, responsively to input by the user to the computer, while the at least some of the content remains visible behind the editing window, so as to modify a characteristic of the image and place a reference to the image, with the modified characteristic, in a desired location in the browser window.

The present invention will be more fully understood from the following detailed description of the embodiments thereof, taken together with the drawings in which:

### BRIEF DESCRIPTION OF THE DRAWINGS

The present invention will be more fully understood from the following detailed description of the embodiments thereof, taken together with the drawings in which:

FIG. 1 is a block diagram that schematically illustrates an on-line image editing system, in accordance with an embodiment of the present invention;

FIG. 2 is a flow chart that schematically illustrates communication between a client and a server in an on-line image editing system, in accordance with an embodiment of the present invention;

FIGS. 3A and 3B are schematic, pictorial illustrations of a user interface screen for an on-line image editing program, in accordance with an embodiment of the present invention; and

FIG. 4 is a schematic, pictorial illustration of a user interface screen for an on-line image editing program, in accordance with another embodiment of the present invention.

### DETAILED DESCRIPTION OF EMBODIMENTS

### Overview

A WYSIWYG markup-language editor provides an editing interface that enables the user to see how a markup page will appear when displayed in a browser. An on-line markup-language editor provides many of the features of a standalone markup-language editor while remaining lightweight, and usually without requiring any kind of installation on a client computer.

One common element of a HyperText Markup Language (HTML) page or other markup-language page is a digital image. Users who wish to incorporate a digital image into a page must generally employ a standalone tool to edit and enhance the image prior to insertion. Some example features of image editing tools are image size alteration, cropping, noise removal, color alteration, orientation, and sharpening or softening of digital images.

After the digital image has been edited in the standalone tool and saved, an appropriate reference to it can then be inserted into the markup-language file. A drawback of this method of markup-language file editing is that the user will often find that the insertion of the enhanced digital image alters the appearance of the markup page in an unwanted fashion. It may only be apparent that the markup page has been altered when the markup language document is saved and the markup-language document is viewed from a browser. The user must then switch back to the image editing tool to make additional changes to the digital image and then re-insert the revised digital image into the markup-language file and again view the updated markup page from a browser. This process may need to be iterated through several times before the desired markup page appearance is achieved.

Embodiments of the present invention streamline the process of image editing by integrating the workflow of an on-line application with a digital image editing tool. The digital image editing tool may be called from an application such as an editor, photograph gallery, or Content Management System (CMS), and opens on top of the existing application (both visually and technically speaking). For example, the application may be an on-line WYSIWYG markup-language editor, in which case the user is able to modify digital images on the fly within a single markup-language editing environment. The WYSIWYG feature enables the user to see how the markup page will appear when displayed in a browser.

In some embodiments, a WYSIWYG integrated digital image editing tool provides a transparent editing window, enabling the contents of the markup page to remain visible behind the digital image editing window. This feature enables the user to edit the digital image and to move the edited image, within the digital image editing tool, to the desired location in the markup page. The user is thus able to see how the edited digital image impacts the appearance of the markup page during the process of image editing. When the user is satisfied, the editor automatically inserts the image into the precise location within the markup page, requiring no further steps to achieve the desired result.

In one embodiment, an on-line markup-language editor automatically edits the markup-language code after the user has edited a digital image with the integrated on-line digital image editing tool. When the contents of the markup file are saved, the modified markup-language is saved together with the edited digital image. When the contents of the markup page are viewed in a browser, the edited digital image is displayed in the desired location.

Users browsing markup-language documents may not always be provided with sufficient bandwidth to display digital images. In addition, some browsers such as those used in some mobile computer devices, may be text-only browsers. In some embodiments, the integrated digital image tool allows the user to specify an alternative text attribute of the digital image. The edited digital image is then saved along with the markup-language file. When the markup-language page is displayed in a browser, and the digital image element is not rendered, the alternative text associated with the digital image is displayed instead.

### System Description

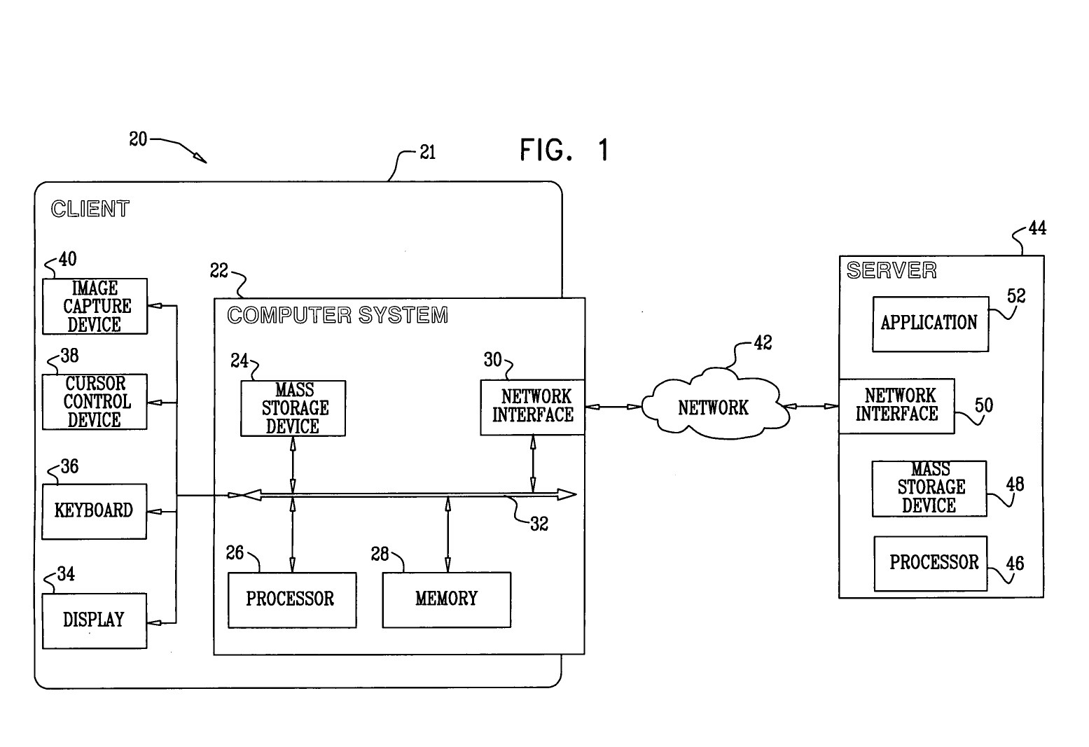

FIG. 1 is a block diagram that schematically illustrates an on-line image editing system 20, in accordance with an embodiment of the present invention. A server 44 and a client 21 communicate over a network 42, such as the Internet. The client receives an image editing application 52 that is embedded in a markup-language page from the network via a network interface 30. The client executes this embedded image editing application, accepts user input for manipulating images, and allows the embedded image editing application to upload modified image characteristics back to the server via the network interface.

Client 21 may include any suitable computer system 22 that is known in the art, such as a desktop personal computer, laptop personal computer, Internet device, hand-held personal computer, Personal Digital Assistant, or tablet personal computer. By way of example, computer system 22 is herein assumed to include a processor 26, a memory 28, network interface 30, and a mass storage device 24, all connected by a bus 32. For the embodiment described below, the computer system should have software installed including a compatible web browser and an Adobe Flash® player. The client typically includes input/output devices such as a display device 34, a keyboard 36 and a cursor control device 38 or other suitable user input devices, which are connected to the computer system in a suitable manner. In some embodiments, the computer system may be connected to an image capture device 40, such as a digital camera or scanner.

Server 44 may comprise any device that can transmit the embedded image editing application in response to a client request received from the network via a network interface 50, and can receive the modified image characteristics from the client. Server 44 may edit a copy of an image received from client 21 in accordance with the received image characteristics. Alternatively, the image may be modified locally by the client and then simply uploaded to the server following modification. The image may initially be provided by the client or by the server, or may be downloaded by the client from another source, and may be stored after editing on the client or the server (or both). The server is herein assumed to include a processor 46, a mass storage device 48, and network interface 50.

The embedded image editing application that is downloaded to client 21 includes an interface for displaying the unedited image, allowing the user to edit the image, and for displaying the image during and after editing. The embedded image editing application further includes an engine for generating manipulation parameters that correspond to the modified image characteristics, and, optionally, for uploading the manipulation parameters to the server.

Server 44 receives and processes the manipulation parameters, and can use the manipulation parameters to modify the version of the digital image that is stored on the server. The server may also store the manipulation parameters as a digital image editing history. Therefore, changes to the digital image can be undone, prior to saving the edited image, if the user desires to revert to an earlier version of the digital image.

The interface of the embedded image editing application may be a graphical user interface (GUI). Some elements of the GUI and some example image editing operations will be described below. In one embodiment, the embedded image editing application comprises a Java applet called by an on-line markup-language editor or otherwise downloaded to the client from a web page. Alternatively or additionally, the embedded image editing application could be implemented as a script, an ActiveX control, or as a browser plug-in, but is not limited to these examples. One example of an embedded application is a Shockwave® Flash® Object embedded in an HTML page as an SWF object, as explained further herein below. The embedded image editing application may be stored on the server in any suitable type of tangible media, such as magnetic, optical or electronic storage media. Alternatively or additionally, the software may be downloaded to the server in electronic form over a network. By definition, however, embedded applications, such as the present image editing application, are capable of executing on the client, using a compatible browser, without being installed or otherwise permanently stored on the client.

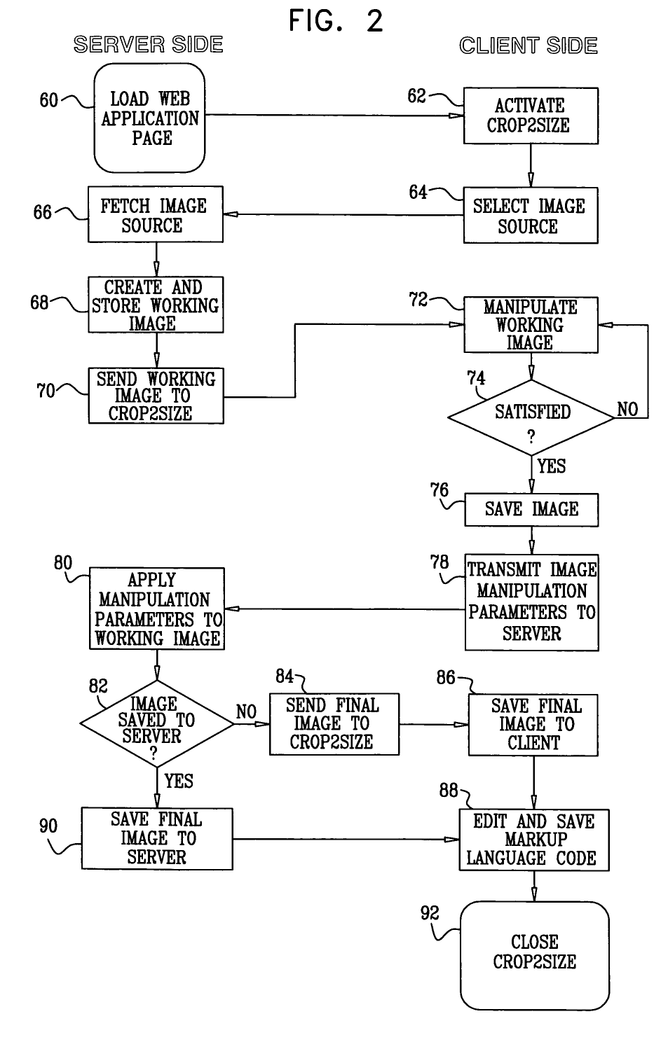

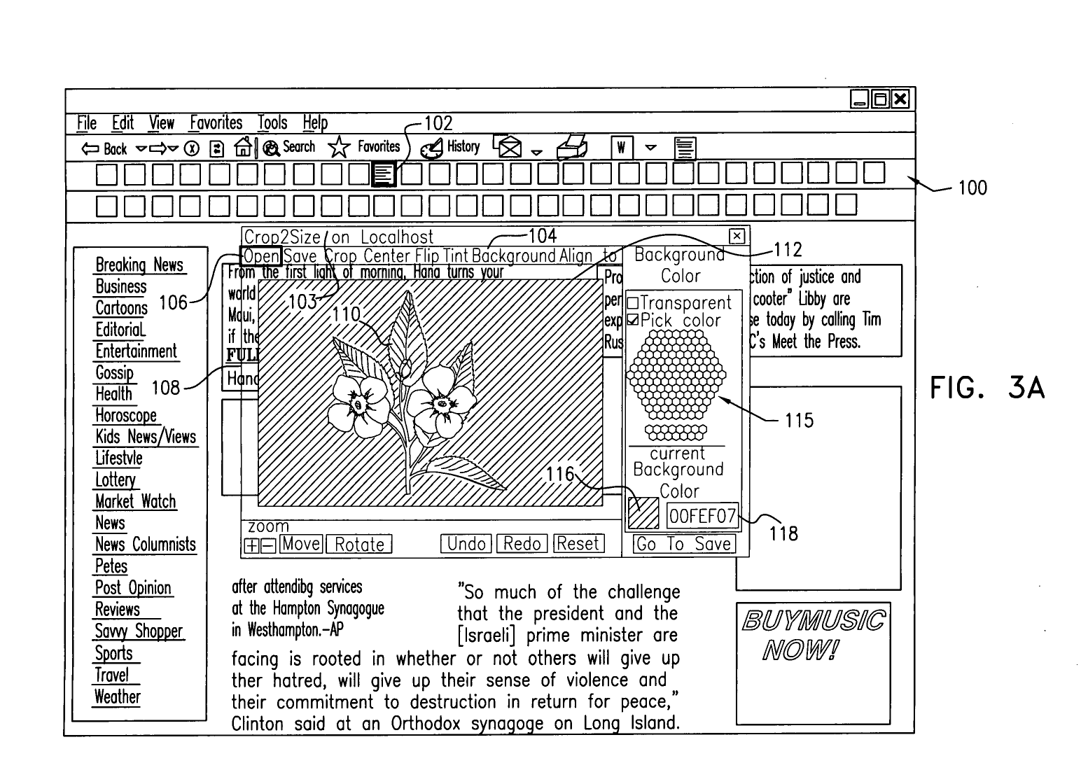

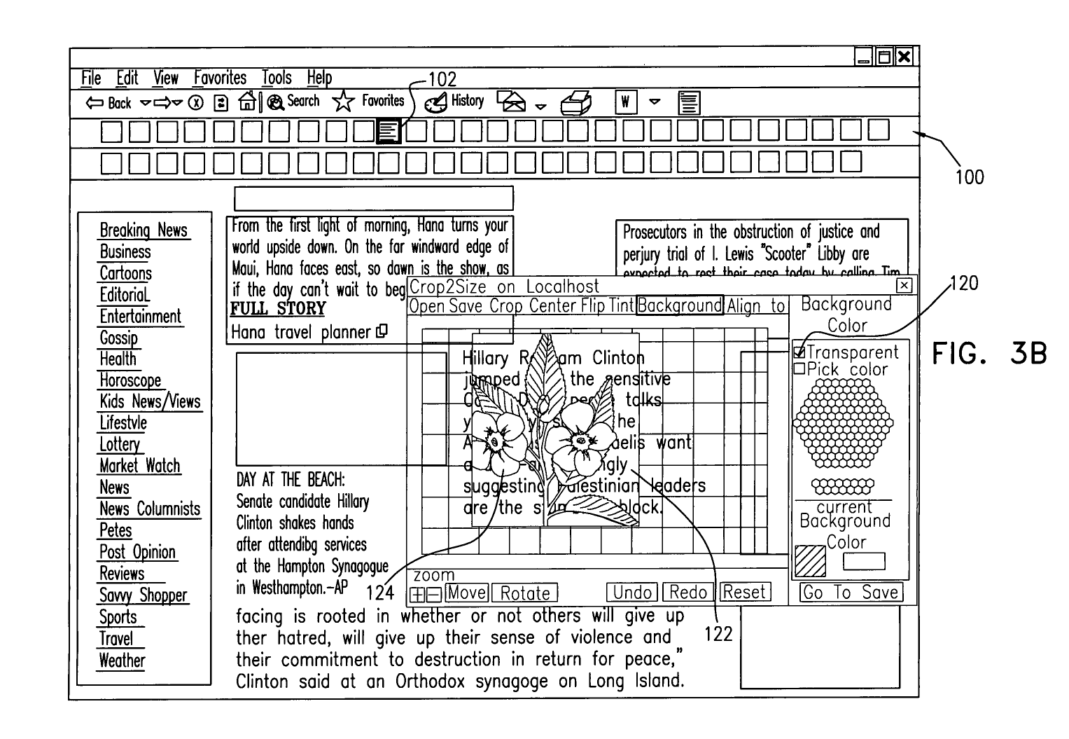

Reference is now made to FIGS. 2, 3A and 3B, which schematically show a method for on-line image editing with embedded image editing application 52, in accordance with an embodiment of the present invention. FIG. 2 is a flow chart showing the steps of the method, including communication between client 21 and server 44. FIGS. 3A and 3B are pictures that schematically illustrate user interface screens in accordance with this method.

In a web application page loading step 60, the client sends a request to the server to provide a web application page including embedded image editing application 52. The application is referred to in FIG. 2 as “Crop2Size™,” since it provides image cropping functions, inter alia. The web application page may include an embedded Shockwave Flash Object (SWF), which provides image display and editing capabilities.

Adobe Flex™ provides a workflow and programming software development kit (SDK) which can be used to create an SWF and is available from Adobe Systems Inc. (San Jose, Calif.). Magic eXtensible Markup Language (MXML), an XML-based markup-language, is used within the Flex SDK to quickly build and layout graphic user interfaces. MXML is the language that developers may use to define the interface of an Adobe Flex application. Interactivity is achieved through the use of ActionScript, the core language of Flash Player that is based on the ECMAScript standard, and is used to define the logic of an application. ECMAScript is a scripting programming language, standardized by Ecma International in the ECMA-262 specification, available at the ecma-international website. The Flex code is compiled by the SDK into an SWF object, which can then be embedded within a markup-language document and loaded at step 60.

An SWF is produced by the Flex software in a proprietary vector graphics file format. Current SWF versions allow audio, video and many different possible forms of interaction with an end user. Once created, SWF files can be played by the Adobe Flash Player, working either as a browser plug-in or as a standalone player. Because the Flash Player can run as a browser plug-in, it is possible to embed an SWF in a markup-language page to provide users with an on-line application that does not have to be installed on their client machine.

In one embodiment, the web application page includes a markup-language editor window 100, shown in FIG. 3A, which is loaded into the user browser.

In an application activating step 62, the user may click on a button icon 102 to launch the Shockwave Flash® Object (SWF) to provide on-line editing of an image for insertion into the markup-language file. After the user presses the button icon to activate the SWF, an image editing window 103 is displayed, partially overlaying the markup-language editor window.

In an image source selecting step 64, the user may click on an “Open” entry 106 in a menu bar 104 to select an image source to edit. The user may be provided with the option to select the image source from client mass storage device 24, client image capture device 40, server mass storage device 48, any other computer accessible via the Internet using HTTP, or from any suitable location known in the art.

In an image source fetching step 66, the server fetches the image source from the location chosen by the user during the image source selection step. Server 44 then creates and stores a copy of the image source, herein referred to as a working image 110, in a working image creating and storing step 68. The server sends the working image to client image editing window 103 via network 42 in a working image sending step 70.

As shown in FIG. 3A, image editing window 103 includes a main viewing area 108. The main viewing area includes working image 110, a working image background 112, and a transparent viewing area frame 108. If any part of the working image is transparent, the user will be able to see through the transparent part to the content behind the editing window. This feature provides another WYSIWYG attribute to the user, whereby the embedded image editing application appears above the markup-language page, maintaining a sense of layering. At least one of the entries in menu bar 104 lists tools for editing the working digital image. Editing tools described in connection with FIGS. 3A and 3B include a cropping tool, a background color editing tool, and a resizing tool. Additional image editing tools commonly known in the art may also be provided.

In a working image manipulating step 72, the editing tools may be utilized by the user to enhance the working image. After each edit is performed, the user may drag the image editing window to a desired location within the markup-language page where the image should be placed. Transparent viewing area frame 108 enables the user to utilize the WYSIWYG functionality of the embedded image editing application. Due to the user's ability to see through the transparent viewing area frame, at least some of the content behind the editing window is visible to the user, and the working image is displayed within the context of the underlying markup-language editing file as it will be viewed in a browser when the markup-language and working image are saved.

In some embodiments, the transparent viewing area frame is provided by configuring a set of parameters in the following manner: An inline frame (IFrame) is an HTML element which enables an application to embed another HTML document inside the main document. The IFrame style attributes are configured to include “background-color:transparent” and ALLOWTRANSPARENCY=“true”. Markup-language editor window 100 is the main HTML document, and image editing window 103 is the embedded document.

The IFrame is used to “layer” the SWF content within the main document, so that the SWF image editing window appears above the page. The background of the SWF may be configured to be transparent, so that the background color or image of the IFrame containing the SWF shows through while the embedded Shockwave Flash Object is layered with the main HTML document. The SWF window is configured to be transparent by adding the following parameters to the attributes used to embed the SWF within a markup page: The object attribute defining the embedded SWF needs to have <PARAM NAME=wmode VALUE=“transparent”> added. In addition, the embed attribute for the embedded SWF needs to include WMODE=“transparent” in the parameter list.

In one embodiment, as noted earlier, the on-line digital image editing application may be an Adobe FLEX™ application which is compiled to produce the SWF. In this case, providing the transparent viewing area frame also requires the Adobe Flex™ MXML Application attribute “mx:Application” to include a parameter “backgroundAlpha” having the value zero, as in backgroundAlpha=“0.0”.

As noted earlier, one of the features of the embedded image editing application may be a cropping tool. When the user selects the cropping tool from the menu bar, it allows the user to edit the working image by selecting a desired portion of the working image. The remaining, unselected part of the working image is discarded. Working image 110 in FIG. 3A is edited with the cropping tool and is then shown as a cropped image 124 in FIG. 3B. The cropped image may be smaller or larger than the original working image while the resolution of the cropped area may or may not remain unchanged. The cropped image may be dragged anywhere within the main markup page, which is visible through the transparent viewing area frame.

Using this cropping tool provides the user with updated markup code including revised manipulation parameters identifying the new image size in addition to the final cropped image. This feature is illustrated by comparing the working image 110 in FIG. 3A to the cropped image 124 in FIG. 3B, shown after the embedded image editing application cropping tool has been applied. The updated markup-language page will include a attribute identifying the location of the image and a reference to the image file. When the image file is saved, as explained below, the file contents will reflect the modified image characteristics. The cropped image may be placed in the desired location by the embedded image editing application automatically by using cascading style sheet (CSS) “absolute positioning,” as described in the current CSS specifications maintained by the W3C (available at the web site of the World Wide Web Consortium, w3.org). However, this approach may prevent markup-language text from wrapping around the cropped image. (A future version of the CSS specification may provide support for wrapping markup-language text around an image that has been assigned an absolute position, which could alleviate this issue.) Alternatively, the cropped image may be placed in the markup-language page in the original image location. The user may then use the WYSIWYG markup-language editor to adjust the cropped image or to wrap the markup-language text around the image as required.

Returning to FIG. 3A, another example to illustrate use of embedded image editing application 52 may be provided by the background color editing tool. When the user selects the background color editing tool from the menu bar, it allows the user to edit the working image by altering working image background 112 to have a different color. A working image background color 116 may be selected from a color palette 115 by clicking the cursor control device on the desired color within the color palette. Alternatively, the working image background color may be chosen by typing a RGB hexadecimal color value in an RGB hexadecimal color box 118. The selection of a different working image background color results in a change to working image background 112 to the desired color. The image may be dragged anywhere within the main markup page visible through the transparent viewing area frame. Using the embedded image editing application background color selection tool provides the user with updated markup code.

Configuration of the embedded image editing application to have background transparency can also be advantageous when editing transparent graphics interchange format (GIF) images. When editing a transparent GIF as working image 110, the user may check a background color transparency selection box 120 as shown in FIG. 3B. A transparent working image background 122 is shown in FIG. 3B, illustrating the transparency of the digital image background after transparency selection box 120 has been checked by the user. The image may be dragged anywhere within the main markup page visible through the transparent viewing area frame or through the transparent image background.

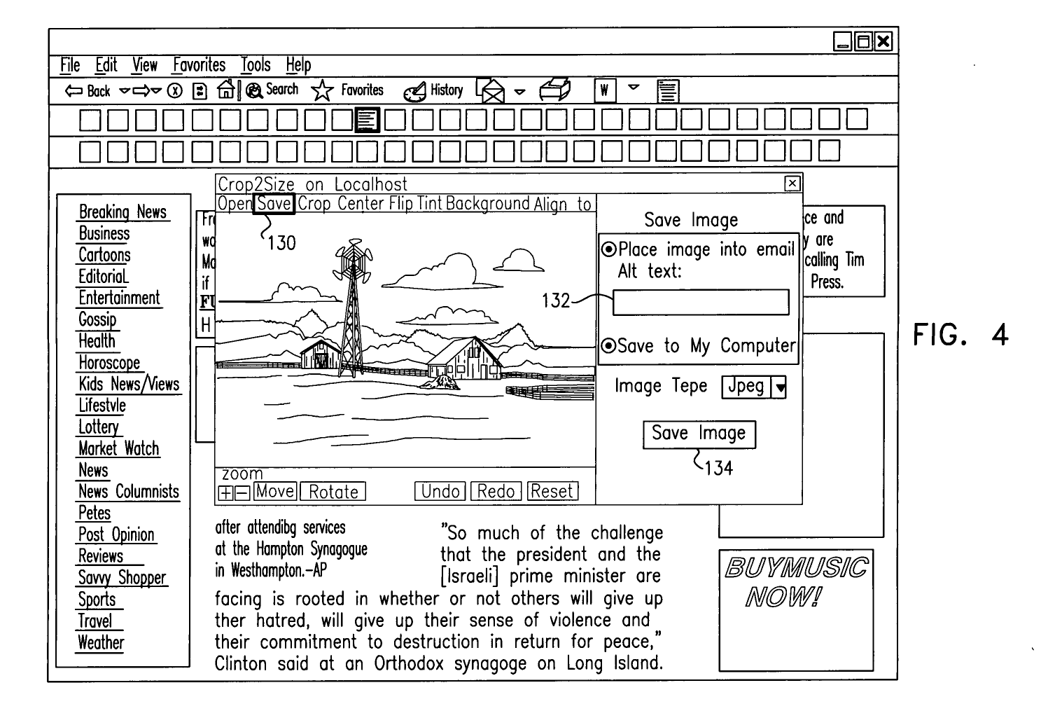

When the user has completed editing of the working image, a “Save” entry 130 in the menu bar shown in FIG. 4 may be selected in an image saving step 76. The user may be provided with the option to save the working image to client mass storage device 24, server mass storage device 48, or any other computer accessible via the Internet using HTTP or to any other suitable device or location known in the art.

In an image manipulation parameter transmitting step 78, the embedded image editing application sends all of the edits that the user has performed to server 44. The image manipulation parameters are applied by server processor 46 to the working image in a manipulation parameter application step 80, resulting in a final image. If the user has chosen to store the final image on the server, the final image is stored in server mass storage device 48 in a final image saving step 90.

Alternatively, the user may choose to store the final image on the client. In this case, the server transmits the final image to the client via the network in a final image sending step 84. The final digital image is then stored in client mass storage device 24 in a final image saving step 86.

In some embodiments, when the embedded image editing application saves the final image, it may export final image data via ExternalInterface JavaScript calls. The final image data typically includes the filename and location, and may also include some text to be used for ALT and TITLE markup-language attributes as described below. This data may then be received by the WYSIWYG markup-language editor, such as FCKeditor, which writes the final image object into the markup-language file, including the ALT and TITLE markup-language attributes where appropriate.

In some embodiments, following step 86 or 90, the markup-language editor may automatically apply changes exported by digital image editing application 52 and save them, in a markup-language editing and saving step 88. As described above, changes exported by the embedded image editing application may include, but are not limited to, modified image size, image location within the markup-language page, in addition to the edited image itself. The markup-language editor generates attributes representing these image parameters in the markup-language code of the page in which the image is to be displayed. In an application closing step 92, the user may then choose to close the digital image editing application and to exit.

Reference is now made to FIG. 4, which is a picture that schematically illustrates a user interface screen of an on-line image editing system, in accordance with another embodiment of the present invention. When the user has completed editing the working digital image, he may select Save entry 130 in the menu bar. The user is provided with an ALT text entry box 132 for adding a markup attribute to the digital image. The user may enter text into the ALT text entry box. When the user clicks on a “Save Image” button 134, the alternative text attribute markup attribute of the IMG attribute, including the contents of the ALT text entry box, is saved in addition to the final digital image.

Digital images may be embedded in markup-language files such as HTML by using an “<img>” attribute. The <img> attribute has two attributes related to alternative text, ALT and TITLE. The W3C standard for markup-language, available at the web site of the World Wide Web Consortium (w3.org), provides that browsers are to show the TITLE attribute in a tool-tip when the cursor is placed over the digital image, and to show the ALT text only when the browser is incapable of or is blocked from showing digital images. The most commonly used browser, Microsoft® Internet Explorer®, does not adhere to the W3C standard. It ignores the TITLE attribute and uses the ALT text in a tool-tip when the cursor is placed over a digital image and when the browser is incapable of images displaying digital images. Therefore, in some embodiments, the on-line digital image editing application may set both the ALT and the TITLE attributes to have the identical value, including the text entered by the user in the ALT text entry box.

In some embodiments, the digital image editing application may receive a JavaScript call while fetching a digital image that indicates that a value exists for the ALT markup-language attribute of the digital image. The JavaScript call is made by the SWF as “Crop2SizeObject.js:flash.setAltText(.Image.alt);”, wherein “setAltText” is an Adobe Flex ActionScript function that may be called externally, “.Image” refers to the <img> attribute, and “.alt” refers to the ALT attribute of the image. The embedded image editing application may store the pre-existing ALT text value in ALT text entry box 132 so that it can be retained or edited by the user before the image is saved.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art.

1. A method for editing, comprising:
processing a page of markup-language code using a browser program running on a computer so as to display content of the page in a browser window on a computer screen;
using an embedded application, which is embedded as an object in the markup-language code, and runs in the browser program, overlaying an image in a transparent editing window on the browser window so that at least some of the content behind the editing window is visible to a user of the computer; and
responsively to input by the user to the computer, editing the image in the transparent editing window, while the at least some of the content remains visible behind the editing window, so as to modify a characteristic of the image and place a reference to the image, with the modified characteristic, in the markup-language code.

2. The method according to claim 1, and comprising, after editing the image, automatically editing the markup-language code using the embedded application running on the computer, so that when the content of the page is displayed, the image, with the modified characteristic, is displayed together with the content in a desired location.

3. The method according to claim 2, wherein automatically editing the markup-language code comprises inserting one or more markup-language attributes associated with the image in the page of the markup-language code, and updating the attributes responsively to the modified characteristic.

4. The method according to claim 1, wherein the embedded application comprises an interactive client application.

5. The method according to claim 4, wherein the interactive client application comprises at least one application type selected from a group of application types consisting of an applet, a script, and a browser plug-in.

6. The method according to claim 1, wherein overlaying an image comprises creating an inline frame markup-language document containing the transparent editing window, and layering the inline frame markup-language document above another markup-language document corresponding to the page of markup-language code.

7. The method according to claim 6, wherein the inline frame markup-language document has at least one transparent style attribute.

8. The method according to claim 1, wherein editing the image comprises cropping the image.

9. The method according to claim 1, wherein the editing window comprises a text entry box for receiving from the user text for association with the image, and wherein automatically editing the markup-language code comprises generating at least one markup-language attribute containing the text.

10. The method according to claim 9, wherein at least one markup-language attribute is selected from a group of attributes consisting of ALT and TITLE attributes.

11. The method according to claim 1, wherein processing the page of markup-language code comprises downloading the page with the embedded application from a server to the computer in response to a request from a client to the server, for editing of the image by the client.

12. The method according to claim 11, wherein editing the image comprises modifying the characteristic of the image on the computer, and then uploading the modified characteristic to the server for application to a copy of the image held by the server.

13. Apparatus for editing, comprising:
a network interface, which is configured to communicate over a network with a client computer; and
a processor which is coupled to download over the network to the client computer a page of markup-language code comprising an embedded application, which is embedded as an object in the markup-language code, so as to cause a browser program running on the client computer to display content of the page in a browser window on a computer screen and to run the embedded application in the browser program,
wherein the embedded application, when run on the client computer, causes the client computer to overlay an image in a transparent editing window on the browser window so that at least some of the content behind the editing window is visible to a user of the computer, and to edit the image in the transparent editing window, responsively to input by the user to the computer, while the at least some of the content remains visible behind the editing window, so as to modify a characteristic of the image and place a reference to the image, with the modified characteristic, in the markup-language code.

14. The apparatus according to claim 13, wherein the embedded application causes the client computer to automatically edit the markup-language code after editing the image, so that when the content of the page is displayed, the image, with the modified characteristic, is displayed together with the content in a desired location.

15. The apparatus according to claim 14, wherein the embedded application causes the client computer to insert one or more markup-language attributes associated with the image in the page of the markup-language code, and to update the attributes responsively to the modified characteristic.

16. The apparatus according to claim 13, wherein the embedded application comprises an interactive client application.

17. The apparatus according to claim 13, wherein the embedded application causes the client computer to create an inline frame markup-language document containing the transparent editing window, and to layer the inline frame markup-language document above another markup-language document corresponding to the page of markup-language code.

18. The apparatus according to claim 17, wherein the inline frame markup-language document has at least one transparent style attribute.

19. The apparatus according to claim 13, wherein the editing window comprises a text entry box for receiving from the user text for association with the image, and wherein the embedded application causes the client computer to generate at least one markup-language attribute containing the text.

20. The apparatus according to claim 13, wherein the embedded application causes the client computer to modify the characteristic of the image on the client computer, and then to upload the modified characteristic to the server for application to a copy of the image held by the server.

21. A computer software product, comprising a tangible computer-readable medium in which program instructions are stored, which instructions, when read by a server, cause the server to download to a client computer a page of markup-language code comprising an embedded application, which is embedded as an object in the markup-language code, so as to cause a browser program running on the client computer to display content of the page in a browser window on a computer screen and to run the embedded application in the browser program,
wherein the embedded application, when run on the client computer, causes the client computer to overlay an image in a transparent editing window on the browser window so that at least some of the content behind the editing window is visible to a user of the computer, and to edit the image in the transparent editing window, responsively to input by the user to the computer, while the at least some of the content remains visible behind the editing window, so as to modify a characteristic of the image and place a reference to the image, with the modified characteristic, in a desired location in the browser window.

22. The product according to claim 21, wherein the embedded application causes the client computer to automatically edit the markup-language code after editing the image, so that when the content of the page is displayed, the image, with the modified characteristic, is displayed together with the content in the desired location.

23. The product according to claim 22, wherein the embedded application causes the client computer to insert one or more markup-language attributes associated with the image in the page of the markup-language code, and to update the attributes responsively to the modified characteristic.

24. The product according to claim 21, wherein the embedded application comprises an interactive client application.

25. The product according to claim 21, wherein the embedded application causes the client computer to create an inline frame markup-language document containing the transparent editing window, and to layer the inline frame markup-language document above another markup-language document corresponding to the page of markup-language code.

26. The product according to claim 25, wherein the inline frame markup-language document has at least one transparent style attribute.

27. The product according to claim 21, wherein the editing window comprises a text entry box for receiving from the user text for association with the image, and wherein the embedded application causes the client computer to generate at least one markup-language attribute containing the text.

28. The product according to claim 21, wherein the embedded application causes the client computer to modify the characteristic of the image on the client computer, and then to upload the modified characteristic to the server for application to a copy of the image held by the server.
